(19) United States
(12) Patent Application Publication
(10) Pub. No.: US 2024/0318784 A1
(43) Pub. Date: Sep. 26, 2024

(54) COMPRESSION DEVICE AND METHOD

(71) Applicant: L'Air Liquide, Societe Anonyme pour l'Etude et l’Exploitation des Procedes Georges Claude, Paris (FR)

(72) Inventor: Rasmey TRY, Sassenage (FR)

(73) Assignee: L'Air Liquide, Societe Anonyme pour l'Etude et l’Exploitation des Procedes Georges Claude, Paris (FR)

(21) Appl. No.: 18/612,523

(22) Filed: Mar. 21, 2024

(30) Foreign Application Priority Data
Mar. 21, 2023 (FR) FR 2302594

(51) Int. Cl. F17C 5/04; F17C 7/02

(52) U.S. Cl. CPC F17C 5/04; F17C 7/02; F17C 2227/0164

(57) ABSTRACT

The invention relates to a device for compressing a fluid, said device having a compression chamber accommodating a piston that is able to move in translation between the first and second ends of the compression chamber, the device comprising a regeneration circuit connecting the first and second ends of the compression chamber and having a regenerator, the supply pipe comprising a set of one or more valves, the device comprising at least one pipe for discharging the compressed fluid, said discharge pipe comprising an upstream end connected to the compression chamber and a downstream end intended to be connected to a receiver of the compressed fluid, wherein the regeneration circuit comprises, between the regenerator and the first end of the compression chamber, a heat exchanger that is configured to ensure an exchange of heat between the flow of fluid that has passed through the regenerator and a cold source.

### CROSS REFERENCE TO RELATED APPLICATIONS

This application claims the benefit of priority under 35 U.S.C. § 119 (a) and (b) to French patent application No. FR2302594, filed Mar. 21, 2023, the entire contents of which are incorporated herein by reference.

### FIELD OF THE INVENTION

The invention relates to a compression device and method.

### BACKGROUND OF THE INVENTION

Documents FR2904401A1 and FR3007077A1 describe such a compression device, which is sometimes referred to as a “thermal compressor”.

Devices of this type may provide satisfactory efficiency. Solutions are sought to improve this efficiency and for example the energy optimization for managing the pressure in the supply storage of the device.

When in operation, such a device usually comprises the following steps.

Compression: the piston is in an end position in the second end of the compression chamber (relatively hot side of the device). The valve of the supply pipe has been opened, fluid (gas or liquid) has previously been introduced and fills the volume of the first end of the compression chamber (from the pressurized tank or via a pump). The piston is then actuated towards the first end of the compression chamber. This leads to a transfer of fluid from the (cold) first end towards the (hot) second end. In practice, the force needed is limited only by the transfer impedance of transferring the gas through the regenerator.

As the gas is heated in the hot second end, the pressure in the system begins to increase. The valve of the supply pipe is closed and the valve of the discharge pipe remains closed as long as the pressure is below an opening threshold (for example the pressure of an outlet tank connected to the discharge pipe). The mass of excess fluid is then expelled via the valve of the discharge pipe at a preferably constant pressure. When the piston reaches the end position thereof at the closed end of the first end of the compression chamber, it preferably occupies all of this end volume of the compression chamber. During the transfer from the hot chamber towards the cold chamber, the cold of the fluid coming from the cold chamber stores the cold in the walls of the regenerator, which cold will be restored to the fluid in the regeneration phase.

Regeneration: the piston is again moved towards the second end of the compression chamber (regeneration phase). This moves the fluid from the (hot) second end towards the (cold) first end of the compression chamber. During this process, the flow of mass moves from the (hot) second end towards the (cold) first end. The fluid recovers the cold stored in the walls of the regenerator. As the fluid cools, the pressure in the compression device begins to drop. When the pressure in the first end of the compression chamber drops below a threshold, the valve of the discharge pipe closes and the valve of the supply pipe may open again to restart the process.

The latter step may generate a significant loss of efficiency of the thermal compressor. The fluid returning from the hot chamber effectively carries the inefficiencies of the regenerative exchanger (temperature pinch) and of compression (temperature differential caused by the compression in the previous cycle).

For example, in the case of the compression of liquid hydrogen from 1 bar to 20 bar, the temperature naturally increases from 20.2 K to 21.1 K as a result of the compression. This means that the cold side of the regenerator will be at least at a temperature of 21.1 K. This means that the fluid returning from the hot chamber will be at best equal to or greater than 21.1 K, plus the pinch of the regenerator. The amount of heat injected into the cold chamber then corresponds to the return flow rate from the hot chamber multiplied by the enthalpy difference between 20.2 K and 21.1 K.

### SUMMARY OF THE INVENTION

In certain embodiments, the invention relates more particularly to a device for compressing a fluid, said device having a compression chamber accommodating a mobile piston, the device comprising a first end accommodating a first end of the compression chamber, the device comprising a second end accommodating a second end of the compression chamber, the piston being able to move in translation between the first and second ends of the compression chamber, the device comprising a regeneration circuit connecting the first and second ends of the compression chamber and having a regenerator, the device comprising a supply pipe comprising an upstream end intended to be connected to a source of fluid to be compressed and a downstream end opening into the first end of the compression chamber, the supply pipe comprising a set of one or more valves, the device comprising at least one pipe for discharging the compressed fluid, said discharge pipe comprising an upstream end connected to the compression chamber and a downstream end intended to be connected to a receiver of the compressed fluid.

The invention proposes an improvement in the efficiency of the thermal compressor and/or an energy optimization in order to reduce the energy consumed to pressurize the supply storage of the thermal compressor.

To this end, the device according to certain embodiments of the invention, which is otherwise in accordance with the generic definition thereof given in the preamble above, is essentially characterized in that the regeneration circuit comprises, between the regenerator and the first end of the compression chamber, a heat exchanger that is configured to ensure an exchange of heat between the flow of fluid that has passed through the regenerator and a cold source.

In addition, embodiments of the invention may have one or more of the following features:
the cold source comprises a flow of cryogenic fluid,
the source of fluid to be compressed comprises a tank of liquefied fluid, for example of liquefied cryogenic fluid, and is connected to the upstream end of the supply pipe, the cold source comprising a pipe for tapping off a cryogenic fluid flow from the source of fluid and providing a passage through the heat exchanger,
the tap-off pipe branches off from the supply pipe,
the tap-off pipe describes a loop that is connected to the source of fluid and configured to form a thermosiphon,
the tap-off pipe comprises a set of one or more valves, for example at least one valve for regulating pressure and/or flow rate,
the set of one or more valves of the supply pipe comprises a non-return member such as a non-return valve,
the second end of the device comprises a heating system,
the first end of the device comprises a cooling or heating system,
the regenerator comprises a heat exchanger tube, in particular a cylindrical tube, that is filled with a material configured to store and release the heat and to allow the fluid in the liquid and/or gaseous state to pass through.

The invention can also relate to a method for compressing fluid by means of a device in accordance with any one of the features above or below, characterized in that it comprises the following successive steps: a) admitting a fluid in the liquid state at an initial pressure into the first end of the compression chamber via the supply pipe, b) compressing, by moving the piston towards the first end of the compression chamber, and transferring the fluid from the first end of the compression chamber towards the second end of the compression chamber via the regeneration pipe, the second end of the device being maintained at a temperature that is higher than the temperature of the first end, c) regenerating, by moving the piston towards the second end of the compression chamber, and transferring the fluid from the second end of the compression chamber towards the first end of the compression chamber via the regenerator, the method comprising, during the regeneration step c), a step of cooling the flow of fluid that has passed through the regenerator.

According to other possible particular features, the fluid in the liquid state is admitted at an initial pressure into the first end of the compression chamber from a tank of liquefied fluid, and the cooling step uses fluid from the tank to cool the flow of fluid.

The invention may also relate to any alternative device or method comprising any combination of the features above or below within the scope of the claims.

Further particular features and advantages will become apparent upon reading the description below, which is provided with reference to the FIGURES.

### BRIEF DESCRIPTION OF THE DRAWINGS

Further features and advantages of the invention will become apparent from the description hereinafter of embodiments, which are given by way of illustration but without any limitation, the description being given in relation with the following attached FIGURES:

FIG. 1 shows a schematic and partial cross-sectional view illustrating an example of the structure and operation of an exemplary embodiment of a compression device according to the invention.

### DETAILED DESCRIPTION OF THE INVENTION

Throughout the FIGURES, the same reference signs relate to the same elements.

In this detailed description, the following embodiments are examples. Although the description refers to one or more embodiments, this does not mean that the features apply only to a single embodiment. Individual features of different embodiments may also be combined and/or interchanged in order to provide other embodiments.

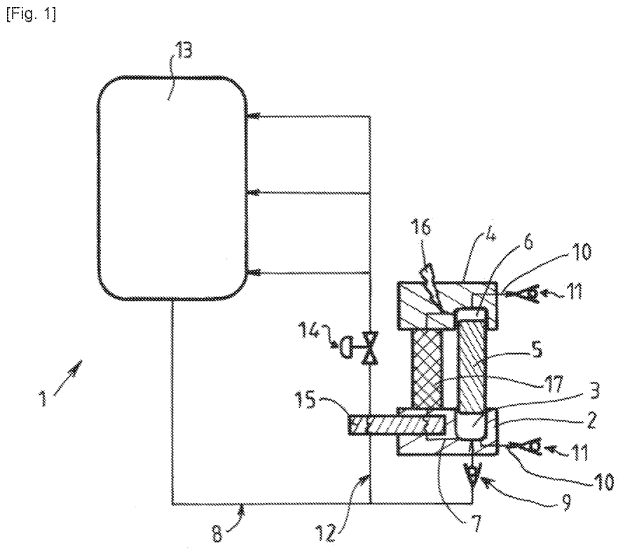

The device 1 for compressing a fluid illustrated in [FIG. 1] (or “thermal compressor”) comprises a frame or casing accommodating a compression chamber in which a mobile piston 5 is housed. The device 1 comprises a first end 2 accommodating a first end 3 of the compression chamber (relatively cold end), the device 1 comprising a second end 4 accommodating a second end 6 of the compression chamber (relatively hot end). In this compressor, the two chambers or ends 3, 6 are usually practically at the same pressure, discounting the pressure losses of the regenerative exchanger. A heating system 16 may be provided at the second end.

The piston 5 is able to move in translation between the first 3 and second 6 ends of the compression chamber (via any suitable drive system, which for the sake of simplicity is not described).

The device 1 comprises a regeneration pipe 7 connecting the first 3 and second 6 ends of the compression chamber and having a regenerator 17.

The device 1 also comprises a supply pipe 8 having an upstream end intended to be connected to a source 13 of fluid to be compressed and a downstream end opening into the first end 3 of the compression chamber. The source 13 is preferably a tank of cryogenic fluid, for example of liquefied hydrogen.

The tank 13 preferably contains a cryogenic fluid in two-phase form and supplies the thermal compression device with liquid, which is preferably in a state close to saturation and may potentially be subcooled. The diagram does not show any members for controlling the pressure in the tank 13 (pressurization and/or depressurization system), which may be provided in a conventional manner.

The supply pipe 8 comprises a set of one or more valves, in particular a non-return valve 9. The device 1 comprises at least one pipe 10 for discharging the compressed fluid, said discharge pipe comprising an upstream end connected to the compression chamber and a downstream end intended to be connected to a receiver of the compressed fluid. This discharge pipe 10 also comprises a set of one or more valves, for example a non-return valve 11.

For example, the upstream end of the pipe 10 for discharging the compressed fluid is connected to the first and/or the second end of the compression chamber.

For example, and as illustrated, the device 1 may comprise two discharge outlets (from the hot chamber and from the cold chamber). It is also possible to envisage a discharge at an intermediate temperature between these two ends.

For example, the upstream end of the pipe 10 for discharging the compressed fluid is connected to the first end 3 of the compression chamber. This means that the compressed fluid is discharged from the relatively cold end 3 of the device 1. This enables relatively cold compressed fluid to be produced.

The regeneration pipe 7 is preferably separate from the discharge pipe 10. This means that this regeneration pipe 7 connects the two ends 3, 6 of the compression chamber by passing through the regenerator 17 and thus allows only direct passage between these ends during the movements of the piston 5.

The downstream end of the supply pipe 8 is preferably connected directly to the first end 3 of the compression chamber, i.e. without passing through a pre-compression chamber. This means that the fluid to be compressed is injected directly into the compression chamber 3.

Conventionally, the regenerator 17 may comprise a heat exchanger tube, in particular a cylindrical tube, that is filled with a material configured to store and release the heat and to allow the fluid in the liquid and/or gaseous state to pass through. Of course, any other suitable heat exchanger structure may be envisaged.

Operation may be as follows. In a first compression step, the (cold) first end 3 is filled with cold fluid supplied by the tank 13. The (hot) second end 6 is at its minimum volume. The piston 3 is moved from the second end 6 towards the first end 3, forcing the fluid to pass through the regenerator 17. The fluid heats up in the regenerator and optionally in an additional exchanger.

The fluid thus heated enables the ends 3, 6 of the compression chamber to be pressurized (identical pressure). Once the delivery pressure has been reached, the outlet valve 11 opens. In a subsequent regeneration and injection phase, the piston 5 is moved from the first end 3 towards the second end 6, thus forcing the fluid to pass through the regenerator 17 again. The fluid cools and enables the pressure inside the compressor to reduce. Once this pressure is lower than the pressure in the tank 13, the supply valve 9 opens. Thus, the incoming fluid (coming from the tank 13) and the fluid returning from the regenerator 17 mix together in the cold chamber (first end 3). The level of liquid in the supply tank is reduced, which causes the pressure inside the tank 13 to reduce. An internal or external pressurization system may make it possible to maintain a pressure therein.

According to one advantageous particular feature, the device 1 comprises, preferably at the regeneration circuit 7, between the regenerator 17 and the first end 3 of the compression chamber, a heat exchanger 15 that is configured to ensure an exchange of heat between the flow of fluid that has passed through the regenerator 17 and a cold source.

Integrating such a heat exchanger 15 onto the cold portion of the thermal compressor makes it possible to carry out a thermal exchange between the fluid returning from the hot second chamber (end 6) of the thermal compressor, the flow of which carries the inefficiencies of the exchange of heat with the above-described regenerative exchanger (regenerator 17). This makes it possible to cool the fluid returning from the second end 6 to a temperature close to the temperature of the liquid admitted at the inlet into the first end 3. This reduces the amount of heat returned to the cold chamber (first end 3) on account of the inefficiency of the compression.

As illustrated, the cold source may comprise a pipe 12 for tapping off a cryogenic fluid flow from the source 13 of fluid and providing a passage through the heat exchanger 15. For example, the tap-off pipe branches off from the supply pipe 8.

The cold fluid may be tapped off from the supply to the thermal compressor, which corresponds to the coldest point of the system. Upon passing through the cold heat exchanger 15, this branch of the supply to the thermal compressor heats up and may vaporize.

As illustrated, the tap-off pipe 12 may form a loop having two ends that are connected to the source 13 of fluid and the loop is configured to form a thermosiphon.

Thus, the fluid returning from the hot chamber 6 or second end of the thermal compressor returns to the chamber or cold end 3 at a temperature close to the temperature of the incoming fluid and is mixed with the supply fluid. Using this heat exchanger 15 thus makes it possible to improve the liquid content of the cold chamber (first end 3). This improves the efficiency of the thermal compressor. The tap-off pipe 12 may comprise a set of one or more valves 14, for example at least one valve for regulating pressure and/or flow rate.

The cryogenic cold fluid supplied by the tank 13 may have a temperature close to saturation thereof and may evaporate following the thermal exchange in the heat exchanger 15. This fluid may be returned to the tank 13 in order to limit the use of a pressurization system. The fluid may be returned at any level (height) in the tank (in the liquid lower portion or gaseous upper portion). This pressurization takes place with a fluid having a return temperature that is low, for example close to saturation.

This cooling circuit 12 is independent of the thermal compressor. The coupling of the tank 13 to the cooling circuit 12 preferably constitutes a thermosiphon.

Thus, the circulation of the cooling fluid in the heat exchanger 15 is established naturally with a driving force corresponding to the hydrostatic head of the tank 13 and of the heat exchanged in the heat exchanger 15. There is therefore no need for an additional force in order to carry out this circulation.

A regulating valve may be integrated onto the tap-off pipe 12 in order to limit the flow rate of the thermosiphon and therefore regulate the amount of fluid returned to the tank 13 for pressurization thereof.

The compression device 1 may be supplied with gas or liquid. Better compression performance is achieved in the latter case.

The invention is advantageously applied to the compression of liquid hydrogen, but could relate to a fluid chosen from the list comprising He, H2, Ne, CO, Ar, N2, O2, CH4, CO2, NO, Kr, Xe or any mixture of two or more of these chemical species.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

We claim:

1. A device for compressing a fluid, said device comprising:
a compression chamber accommodating a mobile piston;
a first end accommodating a first end of the compression chamber;
a second end accommodating a second end of the compression chamber, the piston being able to move in translation between the first and second ends of the compression chamber;
a regeneration circuit connecting the first and second ends of the compression chamber and having a regenerator;
a supply pipe comprising an upstream end intended to be connected to a source of fluid to be compressed and a downstream end opening into the first end of the compression chamber, the supply pipe comprising a set of one or more valves; and
at least one pipe for discharging the compressed fluid, said discharge pipe comprising an upstream end connected to the compression chamber and a downstream end intended to be connected to a receiver of the compressed fluid, the regeneration circuit comprising, between the regenerator and the first end of the compression chamber, a heat exchanger that is configured to ensure an exchange of heat between the flow of fluid that has passed through the regenerator and a cold source,
wherein the source of fluid to be compressed comprises a tank of liquefied fluid and is connected to the upstream end of the supply pipe, and in that the cold source comprises a pipe for tapping off a cryogenic fluid flow from the source of fluid and providing a passage through the heat exchanger.

2. The device according to claim 1, wherein the tap-off pipe branches off from the supply pipe.

3. The device according to claim 1, wherein the tap-off pipe describes a loop that is connected to the source of fluid and configured to form a thermosiphon.

4. The device according to claim 1, wherein the tap-off pipe comprises a set of one or more valves, for example at least one valve for regulating pressure and/or flow rate.

5. The device according to claim 1, wherein the set of one or more valves of the supply pipe comprises a non-return member such as a non-return valve.

6. The device according to claim 1, wherein the second end of the device comprises a heating system.

7. The device according to claim 1, wherein the first end of the device comprises a cooling or heating system.

8. The device according to claim 1, wherein the regenerator comprises a heat exchanger tube, in particular a cylindrical tube, that is filled with a material configured to store and release the heat and to allow the fluid in the liquid and/or gaseous state to pass through.

9. The method for compressing fluid by means of a device in accordance with any claim 1, the method comprising the following successive steps:
a) admitting a fluid in the liquid state at an initial pressure into the first end of the compression chamber via the supply pipe,
b) compressing, by moving the piston towards the first end of the compression chamber, and transferring the fluid from the first end of the compression chamber towards the second end of the compression chamber via the regeneration pipe, the second end of the device being maintained at a temperature that is higher than the temperature of the first end,
c) regenerating, by moving the piston towards the second end of the compression chamber, and transferring the fluid from the second end of the compression chamber towards the first end of the compression chamber via the regenerator,
wherein, during the regeneration step c), a step of cooling the flow of fluid that has passed through the regenerator.

10. The method according to claim 9, wherein the fluid in the liquid state is admitted at an initial pressure into the first end of the compression chamber from a tank of liquefied fluid, and in that the cooling step uses fluid from the tank to cool the flow of fluid.
